(19) United States
(12) Patent Application Publication
(10) Pub. No.: US 2014/0295273 A1
(43) Pub. Date: Oct. 2, 2014

(54) ANODE, LITHIUM BATTERY INCLUDING THE ANODE, AND METHOD OF PREPARING THE ANODE

(71) Applicants: Samsung SDI Co., Ltd., Yongin-si (KR); Samsung Electronics Co., Ltd., Suwon-si (KR)

(72) Inventors: Sang-kook MAH, Seoul (KR); Jeong-kuk SHON, Hwaseong-si (KR)

(73) Assignees: Samsung SDI Co., Ltd., Yongin-si (KR); Samsung Electronics Co., Ltd., Suwon-si (KR)

(21) Appl. No.: 14/069,530

(22) Filed: Nov. 1, 2013

(30) Foreign Application Priority Data
Mar. 26, 2013 (KR) 10-2013-0032360

(51) Int. Cl. H01M 4/587; H01M 4/1393; H01M 4/04; H01M 4/36

(52) U.S. Cl. CPC H01M 4/587; H01M 4/366; H01M 4/1393; H01M 4/0471
USPC 429/220; 429/231.8; 429/221; 429/231.5; 429/223; 429/225; 429/229; 429/228; 252/506; 427/122

(57) ABSTRACT

An anode, a lithium battery including the anode, and a method of manufacturing the anode. The anode includes: an anode active material including a metal alloyable with lithium; and a metal-carbon composite conducting agent having a density of 3.0 grams per cubic centimeter or greater.

### CROSS-REFERENCE TO RELATED APPLICATIONS

This application claims priority to and the benefit of Korean Patent Application No. 10-2013-0032360, filed on Mar. 26, 2013, and all the benefits accruing therefrom under 35 U.S.C. §119, the content of which is incorporated herein by reference in its entirety.

### BACKGROUND

1. Field

The present disclosure relates to an anode, a lithium battery including the anode, and a method of preparing the anode.

2. Description of the Related Art

Carbonaceous materials have been used as anode active materials in lithium batteries. Examples of carbonaceous active materials are crystalline carbon, such as graphite, and amorphous carbon, such as soft carbon and hard carbon. Amorphous carbon has high capacity but also has high irreversible capacity. Crystalline carbon is still not suitable for use in high-capacity lithium batteries though it has a high theoretical capacity. To overcome these drawbacks, much research into a metal-based anode active material including a metal alloyable with lithium, and intermetallic compound-based anode active materials has been conducted.

Metals such as silicon (Si), tin (Sn), and aluminum (Al) may form alloys with lithium. These metals are alloyable with lithium have a high capacity, for example, a capacity ten times higher than that of graphite. However, such metals undergo volume expansion or shrinkage during charging/discharging, and are consequentially separated from the electrode. Further, an increased specific surface area of the active material may cause significant decomposition of the electrolyte.

Therefore, there remains a need for an improved anode material which provides high capacity and more resistance to degradation.

### SUMMARY

Provided is an anode with improved capacity and improved lifetime characteristics.

Provided is a lithium battery including the anode.

Provided is a method of manufacturing the anode.

Additional aspects will be set forth in part in the description which follows and, in part, will be apparent from the description, or may be learned by practice of the presented embodiments.

According to an aspect, an anode includes: an anode active material including a first metal alloyable with lithium; and a metal-carbon composite conducting agent having a density of 3.0 grams per cubic centimeter or greater.

According to another aspect, a lithium battery includes the anode.

Also disclosed is an electrode including the anode.

According to another aspect, a method of manufacturing an anode includes: combining a metal-carbon composite conducting agent, an anode active material including a first metal alloyable with lithium, and a binder to form the anode, wherein the metal-carbon composite conducting agent is manufactured by: contacting a second metal, an oxide thereof, or a combination thereof and a carbon precursor to prepare a mixture; drying the mixture to obtain a dried product; and calcining the dried product in an inert atmosphere or in a reducing atmosphere to manufacture the metal-carbon composite conducting agent, wherein the second metal is a metal inert to lithium or a metal with low reactivity with respect to lithium.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic cross-sectional view of an embodiment of a composite conducting agent;

FIG. 2 is a graph of intensity (counts) versus scattering angle (degrees two-theta, 2θ) and is an X-ray diffraction (“XRD”) spectrum of a composite conducting agent of Example 1; and

FIG. 3 is a schematic view of an embodiment of a lithium battery.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of an anode, a lithium battery including the anode, and a method of manufacturing the anode will be described in greater detail.

According to an embodiment, an anode includes an anode active material including a first metal alloyable with lithium, and a metal-carbon composite conducting agent having a density of 3.0 grams per cubic centimeter (g/cc) or greater.

Due to the inclusion of the metal-carbon composite conducting agent having a relatively high density, the anode may have a higher porosity than an anode manufactured using an electrode having the same thickness and a similar composition but with a lower-density conducting agent in the same amount. In an embodiment, the anode including a high-density metal-carbon composite conducting agent may include more pores by as many as a reciprocal number of a difference in density between the high-density composite conducting agent and a low-density composite conducting agent. While not wanting to be bound by theory, it is understood that due to the high porosity of the anode, the anode may undergo less volumetric expansion caused from the expansion of an anode active material during charging/discharging, so that the anode may substantially or effectively prevent a decrease in actual discharge capacity per unit volume and provide improved lifetime characteristics, in comparison with an anode using a low-density conducting agent. Further, as opposed to when a low-density active material, such as a nanostructured material such as carbon nanotubes (“CNT”) or graphene is used in an electrode, by using the high-density composite conducting agent, an electrode having increased density may be provided. The second metal in the metal-carbon composite conducting agent may be in the form of a metal, e.g., a metal element having an oxidation state of 0, or may be in the form of a metal oxide.

The metal-carbon composite conducting agent may be a composite of a carbonaceous material with a second metal, which is a metal inert to lithium or a metal with low reactivity with respect to lithium, an oxide thereof, or a combination thereof. The second metal, or oxide thereof, may be inert to lithium, or the second metal may have low reactivity with respect to lithium. The use of the metal-carbon composite conducting agent having a density of 3.0 g/cc or greater and including the second metal, an oxide thereof, or a combination thereof, may provide a higher density to the anode compared to carbonaceous conducting agents.

An amount of the carbonaceous material in the metal-carbon composite conducting agent may be 50 weight percent (wt %) or less, based on a total weight of the metal-carbon composite conducting agent. For example, an amount of the carbonaceous material in the metal-carbon composite conducting agent may be from 0 wt % to 50 wt %, and in some embodiments, 2 wt % to 30 wt %, and in some other embodiments, 4 wt % to 20 wt %, and in still other embodiments, 10 wt % or less, and in yet still other embodiments, 5 wt % or less, based on a total weight of the metal-carbon composite conducting agent.

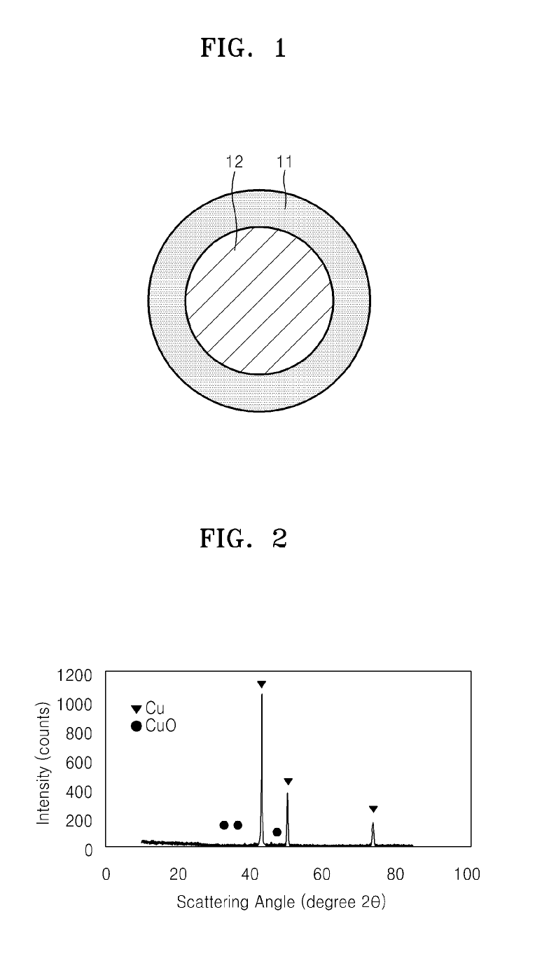

The metal-carbon composite conducting agent may include a core comprising the second metal, an oxide thereof, or a combination thereof; and a carbonaceous coating layer disposed on at least a portion of the core. The carbonaceous coating layer on the core may suppress oxidation of the second metal itself or the surface of the second metal that may occurs in manufacturing a lithium battery. The core of the metal-carbon composite may further include an oxide of the second metal, and/or an oxide of the second metal generated during manufacture of a lithium battery or during preparation of the metal-carbon composite conducting agent. For example, the core of the metal-carbon composite may comprise, or consist of, the second metal, i.e., inert to lithium or having a low activity with respect to lithium. For example, the second metal may have a lithium specific capacity of less than 10 milliampere-hours per gram. An amount of the second metal in the core of the metal-carbon composite conducting agent may be, for example, 99 wt % or more, based on a total weight of the core of the metal-carbon composite conducting agent. In some embodiments, the amount of the second metal in the core of the metal-carbon composite conducting agent may be 90 wt % or more, and in some other embodiments, 80 wt % or more, specifically 80 wt % to 99 wt %, more specifically 85 wt % to 95 wt %, based on a total weight of the core of the metal-carbon composite conducting agent. The metal-carbon composite conducting agent may have a structure with a carbonaceous coating layer 11 on a core 12, as illustrated in FIG. 1.

The second metal comprise Cu, Fe, Zn, Ti, stainless steel, Pb, Co, Ni, or a combination thereof, or an alloy of at least one thereof, but is not limited thereto. Any of a suitable metal that is inert to lithium or has low reactivity with respect to lithium and that has high conductivity may be used for the core of the metal-carbon composite conducting agent.

Also, in another embodiment, tin (Sn), which inherently has high reactivity with respect to lithium, may be used in the form of an alloy with low reactivity metal.

An oxide of the second metal comprise CuO, Cu₂O, FeO, Fe₂O₃, TiO₂, PbO, CoO, NiO, or a combination thereof, but is not limited thereto. Any suitable oxide derived from a metal inert to lithium or a second metal with low reactivity with respect to lithium may be used.

The core of the metal-carbon composite conducting agent may be a composite of a metal inert to lithium or a second metal with low reactivity with respect to lithium, and/or an oxide of such a metal. For example, the core of the metal-carbon composite conducting agent may comprise a composite of a matrix of the second metal inert to lithium or a second metal with low reactivity with respect to lithium and an oxide of the second metal inert to lithium or of the metal with low reactivity with respect to lithium dispersed in the matrix. The core of the metal-carbon composite conducting agent may also comprise a composite of a matrix of an oxide of the second metal inert to lithium or a metal with low activity with respect to lithium, and the second metal inert to lithium or the second metal with low reactivity with respect to lithium dispersed in the matrix. The oxide of the second metals may be formed through oxidation of the second metal or from incomplete reduction of a composite of the second metal and an oxide of the second metal in an inert or reducing atmosphere.

The core of the metal-carbon composite conducting agent may be in the form of a particle, a fiber, a plate, or a combination thereof, but is not limited thereto. The core of the metal-carbon composite conducting agent may have any suitable form available in the art with the ability to facilitate transfer of electrons.

The carbonaceous coating layer of the metal-carbon composite conducting agent may have a thickness of 100 nanometers (nm) or less. For example, the carbonaceous coating layer of the metal-carbon composite conducting agent may have a thickness of 1 nm to 100 nm, and in some embodiments, 1 nm to 80 nm, and in some other embodiments, 1 nm to 60 nm, and in still other embodiments, 1 nm to 50 nm, or 5 nm to 80 nm, 10 nm to 60 nm, or 15 nm to 50 nm. While not wanting to be bound by theory, it is understood that when the thickness of the carbonaceous coating layer of the metal-carbon composite conducting agent is too thick, the anode may have a low density.

The carbonaceous coating layer of the metal-carbon composite conducting agent may be amorphous or low crystalline. While not wanting to be bound by theory, it is understood that the amorphous or low crystalline form may suppress a side reaction of the metal of the core with an electrolyte.

The metal-carbon composite may comprise any suitable carbonaceous material. The carbonaceous material may be amorphous, and may comprise graphene, a mesoporous carbon, a hard carbon, carbon fiber, or a carbon black. The carbonaceous material may comprise an sintering product of 2,3-dihydroxynaphthalene, pitch, tar, sucrose, polyvinylalcohol, polystyrene, phenanthrene, or a combination thereof.

The metal-carbon composite conducting agent may have a conductivity of 10⁻¹ S/cm or greater at 20° C. For example, the metal-carbon composite conducting agent may have a conductivity of 1 S/cm or greater at 20° C., and in some embodiments, 10 S/cm or greater at 20° C., and in some other embodiments, 30 S/cm or greater at 20° C., and in still other embodiments, 60 S/cm or greater at 20° C. Since the metal-carbon composite conducting agent has an electrical conductivity of 10⁻¹ S/cm or greater at 20° C. and a high density, an electrode including the metal-carbon composite conducting agent may have a higher density with the same thickness as an electrode including a lower-density conducting agent.

In the anode, the first metal alloyable with lithium may have a lithium specific capacity of greater than 150 milliampere-hours per gram, and may comprise Si, Ge, Sn, or a combination thereof, but is not limited thereto. Any suitable metal which is alloyable with lithium in the art may be used. For example, the metal alloyable with lithium may be Si or a Si alloy.

In some embodiments, the anode active material of the anode may comprise a core including the first metal alloyable with lithium, and a carbonaceous coating layer on the core of anode active material. Due to having the carbonaceous coating layer on the core of the anode active material, the anode active material may have improved conductivity and the carbonaceous coating layer may prevent or suppress a side reaction of the anode active material with an electrolyte.

The core of the anode active material, including the first metal alloyable with lithium, may be chemically pre-treated, for example, with acid, to select the thickness and the amount of the carbonaceous coating layer on the core of the anode active material. Accordingly, the carbon coated anode active material may have improved electrical conductivity with the same thickness of the carbonaceous coating layer as a carbon coated anode active material prepared without chemical pre-treatment.

The anode active material may have a conductivity of 10⁻⁴ S/cm or greater. For example, the anode active material may have a conductivity of 10⁻³ S/cm or greater, and in some embodiments, 2×10⁻³ S/cm or greater, specifically a conductivity of 10⁻⁴ S/cm to 10⁻² S/cm, specifically 5×10⁻⁴ S/cm to 2×10⁻³. Due to being coated with the carbonaceous coating layer, the anode active material may have improved conductivity.

In the anode, the anode active material and the metal-carbon composite conducting agent may form an electrode structure. A structure, such as an electrode, may be formed from the anode active material and the metal-carbon composite conducting agent. Since the metal-carbon composite conducting agent includes the second metal inert to lithium or the second metal with low reactivity with respect to lithium, a composition including the metal-carbon composite conducting agent and the anode active material may be shaped into a structure in a selected form, for example, through roll-pressing and/or thermal treatment. The metal-carbon composite conducting agent may serve as both a conducting agent and a current collector. For example, the anode may be formed as a film on a ceramic separator.

An electrode comprising the anode may omit a separate current collector in the electrode structure, or may include a current collector. The current collector may comprise a thin metal foil current collector, e.g., an Al or Cu foil having a thickness of 10 μm to 100 μm, or may be a mesh-like current collector, e.g., an expanded metal foil. When the current collector is omitted, the lithium battery may have increased capacity per unit volume.

The metal-carbon composite conducting agent may be manufactured by a method comprising contacting a second metal having a lithium specific capacity of less than 10 milliampere-hours per gram, an oxide thereof, or a combination thereof and a carbon precursor to prepare a mixture; drying the mixture to obtain a dried product; and calcining the dried product in an inert atmosphere or in a reducing atmosphere to manufacture the metal-carbon composite conducting agent.

The anode may be manufacture as follows.

For example, the anode may be manufactured by molding an anode active material composition including the anode active material, the metal-carbon composite conducting agent, and a binder into a desired shape, or coating the anode active material composition on a current collector such as a copper foil, or the like. In some embodiments, the anode active material composition may be in the form of a film on the separator and without the current collector.

In particular, the anode active material, the metal-carbon composite conducting agent, a binder, and a solvent may be combined to prepare the anode active material composition. The anode active material composition may be directly coated on a metallic current collector to prepare an anode. Alternatively, the anode active material composition may be cast on a separate support to form an anode active material film, which may then be separated from the support and laminated on a metallic current collector to prepare an anode. The anode is not limited to the examples described above, and may be one of a variety of types.

In some embodiments, the anode active material composition may further include a second carbonaceous anode active material, in addition to the above-described anode active material. For example, the second carbonaceous anode active material may comprise natural graphite, artificial graphite, expanded graphite, graphene, carbon black, fullerene soot, carbon nanotubes, carbon fiber, or a combination thereof, but is not limited thereto, and may be any suitable carbonaceous material available in the art.

In some embodiments, the anode active material may further include a commercially available carbonaceous conducting agent and/or a non-carbonaceous conducting agent, in addition to the above-described composite conducting agent. Non-limiting examples of the commercially available conducting agent are acetylene black, Ketjen black, natural graphite, artificial graphite, carbon black, carbon fiber, and metal powder and metal fiber of, for example, copper, nickel, aluminum, or silver. In some embodiments at least one conducting material, such as a polyphenylene derivative, may be used in combination. Any conducting suitable agent available in the art may be used.

Non-limiting examples of the binder include a vinylidene fluoride/hexafluoropropylene copolymer, polyvinylidene fluoride (“PVDF”), polyacrylonitrile, polymethylmethacrylate, polytetrafluoroethylene, a styrene butadiene rubber polymer, a polyacrylic acid, polyamideimide, polyimide, or a combination thereof. Any suitable material available as a binding agent in the art may be used.

Non-limiting examples of the solvent are N-methyl-pyrrolidone, acetone, or water. Any suitable material available as a solvent in the art may be used.

The amounts of the anode active material, the metal-carbon composite conducting agent, the binder, and the solvent used in the manufacture of the lithium battery may be determined by one of skill in the art without undue experimentation. At least one of the binder and the solvent may be omitted if desired depending on the use and the structure of the lithium battery.

According to another embodiment, a lithium battery includes the anode. The lithium battery may be manufactured in the following manner.

First, an anode is prepared according to the above-described anode manufacturing method.

Next, a cathode active material, a conducting agent, a binder, and a solvent are combined to prepare a cathode active material composition. The cathode active material composition is directly coated on a metallic current collector and dried to prepare a cathode. Alternatively, the cathode active material composition may be cast on a separate support to form a cathode active material film, which may then be separated from the support and laminated on a metallic current collector to prepare a cathode.

The cathode active material may comprise lithium cobalt oxide, lithium nickel cobalt manganese oxide, lithium nickel cobalt aluminum oxide, lithium iron phosphorous oxide, lithium manganese oxide, or a combination thereof. The cathode active material is not limited to these examples, and may be any suitable cathode active material available in the art.

For example, the cathode active material may be a compound represented by the following formula: LiₐA_{1-b}M_{b}D₂ (where 0.90≦a≦1.8, and 0≦b≦0.5); LiₐE_{1-b}M_{b}O_{2-c}D_{c} (where 0.90≦a≦1.8, 0≦b≦0.5, and 0≦c≦0.05); LiE_{2-b}M_{b}O_{4-c}D_{c} (where 0≦b≦0.5, and 0≦c≦0.05); LiₐNi_{1-b-c}Co_{b}M_{c}D_{α} (where 0.90≦a≦1.8, 0≦b≦0.5, 0≦c≦0.05, and 0≦α≦2); LiₐNi_{1-b-c}Co_{b}M_{c}O_{2-α}X_{α} (where 0.90≦a≦1.8, 0≦b≦0.5, 0≦c≦0.05, and 0≦α≦2); LiₐNi_{1-b-c}Co_{b}M_{c}O_{2-α}X₂ (where 0.90≦a≦1.8, 0≦b≦0.5, 0≦c≦0.05, and 0≦α≦2); LiₐNi_{1-b-c}Mn_{b}M_{c}D_{α} (where 0.90≦a 1.8, 0≦b≦0.5, 0≦c≦0.05, and 0≦α≦2); LiₐNi_{1-b-c}Mn_{b}M_{c}O_{2-α}X_{α} (where 0.90≦a≦1.8, 0≦b≦0.5, 0≦c≦0.05, and 0≦α≦2); LiₐNi_{1-b-c}Mn_{b}M_{c}O_{2-α}X₂ (where 0.90≦a≦1.8, 0≦b≦0.5, 0≦c≦0.05, and 0≦a≦2); LiₐNi_{b}E_{c}G_{d}O₂ (where 0.90≦a≦1.8, 0≦b≦0.9, 0≦c≦0.5, and 0.001≦d≦0.1); LiₐNi_{b}Co_{c}Mn_{d}GeO₂ (where 0.90≦a 1.8, 0≦b≦0.9, 0≦c≦0.5, 0≦d≦0.5, and 0.001≦e≦0.1); LiₐNiG_{b}O₂ (where 0.90≦a≦1.8, and 0.001≦b≦0.1); LiₐCoG_{b}O₂ (where 0.90≦a≦1.8, and 0.001≦b≦0.1); LiₐMnG_{b}O₂ (where 0.90≦a≦1.8, and 0.001≦b≦0.1); LiₐMn₂G_{b}O₄ (where 0.90≦a≦1.8, and 0.001≦b≦0.1); QO₂; QS₂; LiQS₂; V₂O₅; LiV₂O₅; LiIO₂; LiNiVO₄; Li_{(3-f)}J₂(PO₄)₃(where 0≦f≦2); Li_{(3-f)}Fe₂(PO₄)₃(where 0≦f≦2); and LiFePO₄.

In the foregoing formulas, A is nickel (Ni), cobalt (Co), manganese (Mn), or a combination thereof; M is aluminum (Al), nickel (Ni), cobalt (Co), manganese (Mn), chromium (Cr), iron (Fe), magnesium (Mg), strontium (Sr), vanadium (V), a rare earth element, or combination thereof; D is oxygen (O), fluorine (F), sulfur (S), phosphorus (P), or a combination thereof; E is cobalt (Co), manganese (Mn), or combination thereof; X is fluorine (F), sulfur (S), phosphorus (P), or a combination thereof; G is aluminum (Al), chromium (Cr), manganese (Mn), iron (Fe), magnesium (Mg), lanthanum (La), cerium (Ce), strontium (Sr), vanadium (V), or a combination thereof; Q is titanium (Ti), molybdenum (Mo), manganese (Mn), or a combinations thereof; I is chromium (Cr), vanadium (V), iron (Fe), scandium (Sc), yttrium (Y), or combination thereof; and J is vanadium (V), chromium (Cr), manganese (Mn), cobalt (Co), nickel (Ni), copper (Cu), or a combination thereof.

The compounds listed above as cathode active materials may have a surface coating layer (hereinafter, “coating layer”). Alternatively, a mixture of a compound not having a coating layer and a compound having a coating layer, the compounds being selected from the compounds listed above, may be used. The coating layer may comprise an oxide, hydroxide, oxyhydroxide, oxycarbonate, or a hydroxycarbonate. The compounds for the coating layer may be amorphous, polycrystalline, or crystalline. The coating layer may comprise magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a combination thereof. The coating layer may be formed using any suitable method that does not adversely affect the physical properties of the cathode active material. For example, the coating layer may be formed using a spray coating method, a dipping method, or the like. Further details may be determined by one of skill in the art without undue experimentation, and thus further detailed description thereof will be omitted.

Non-limiting examples of the cathode active material are LiNiO₂, LiCoO₂, LiMnₓO₂ₓ (where x=1, 2), LiNi₁₋ₓMnₓO₂ (where 0<x<1), LiNi_{1-x-y}CoₓMn_{y}O₂ (where 0≦x≦0.5 and 0≦y≦0.5), LiFeO₂, V₂O₅, TiS, MoS, or a combination thereof.

The conducting agent, the binder, and the solvent used for the cathode active material composition may be the same as those used for the anode active material composition. Alternatively, a plasticizer may be further added into the cathode active material composition and/or the anode active material composition to form pores in the electrode plates.

The amounts of the cathode electrode active material, the conducting agent, the binder, and the solvent may be determined by one of skill in the art without undue experimentation. At least one of the conducting agent, the binder and the solvent may be omitted if desired according to the use and the structure of the lithium battery.

Next, a separator to be disposed between the cathode and the anode is prepared. The separator may be any suitable separator that is used for lithium batteries. The separator may have a low resistance to migration of ions in an electrolyte and have an excellent electrolyte-retaining ability. Examples of the separator include glass fiber, polyester, Teflon, polyethylene, polypropylene, polytetrafluoroethylene (“PTFE”), or a combination thereof, each of which may be a non-woven or woven fabric. For example, a rollable separator including polyethylene or polypropylene may be used for a lithium ion battery. A separator with a suitable organic electrolyte solution-retaining ability may be used for a lithium ion polymer battery. For example, the separator may be manufactured as follows.

A polymer resin, a filler, and a solvent may be combined to prepare a separator composition. Then, the separator composition may be coated directly on an electrode, and then dried to form the separator. Alternatively, the separator composition may be cast on a support and then dried to form a separator film, which may then be separated from the support and laminated on an electrode to form the separator.

The polymer resin for the separator may be any suitable material that is used as a binder for electrode plates. Examples of the polymer resin are a vinylidenefluoride/hexafluoropropylene copolymer, polyvinylidene fluoride (“PVDF”), polyacrylonitrile, polymethylmethacrylate, or a combination thereof.

The separator may include a ceramic component for improved performance. For example, the separator may be manufactured via coating with an oxide or may be manufactured using ceramic particles.

Next, an electrolyte is prepared.

For example, the electrolyte may be an organic electrolyte solution. Alternately, the electrolyte may be in a solid phase. Non-limiting examples of the electrolyte include lithium oxide and lithium oxynitride. Any suitable material available as a solid electrolyte in the art may be used. The solid electrolyte may be formed on the anode by, for example, sputtering.

In some embodiments, an organic electrolyte solution may be prepared by dissolving a lithium salt in an organic solvent.

The organic solvent may be any suitable solvent available as an organic solvent in the art. Examples of the organic solvent include propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, chloroethylene carbonate, benzonitrile, acetonitrile, tetrahydrofuran, 2-methyltetrahydrofuran, γ-butyrolactone, dioxolane, 4-methyldioxolane, N,N-dimethyl formamide, dimethyl acetamide, dimethylsulfoxide, dioxane, 1,2-dimethoxyethane, sulfolane, sulforane, dichloroethane, chlorobenzene, nitrobenzene, diethylene glycol, dimethyl ether, or a combination thereof.

The lithium salt may be any suitable material available as a lithium salt in the art. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are natural numbers), LiCl, LiI, or a combination thereof.

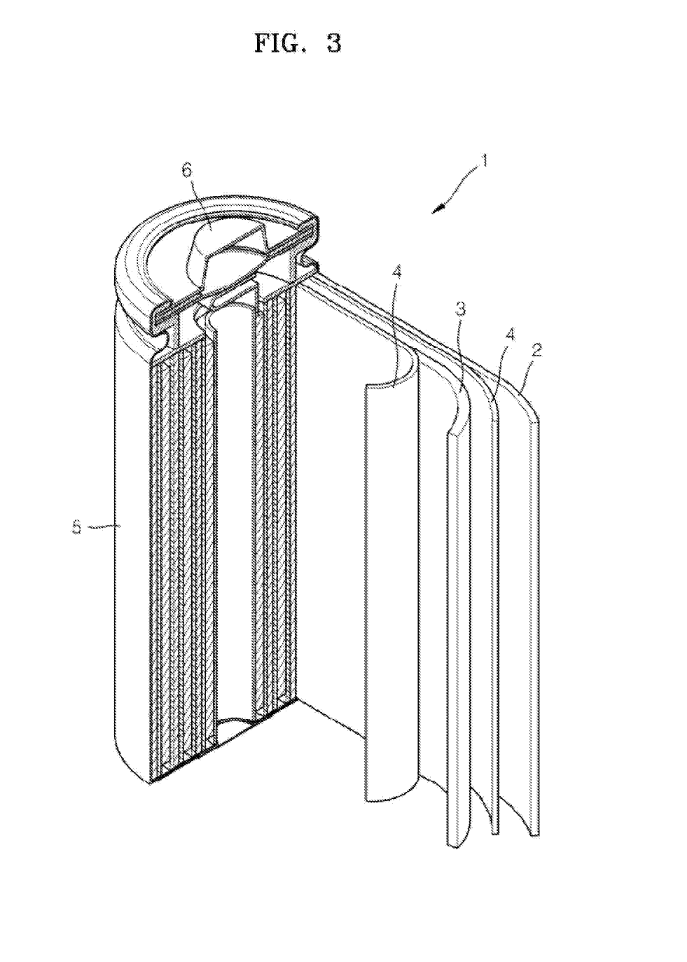

Referring to FIG. 3, a lithium battery 1 includes a cathode 3, an anode 2, and a separator 4. The cathode 3, the anode 2 and the separator 4 may be wound or folded, and then sealed in a battery case 5. Then, the battery case 5 may be filled with an organic electrolyte solution and sealed with a cap assembly 6, thereby completing the manufacture of the lithium battery 1. The battery case 5 may be a cylindrical type, a rectangular type, prismatic, or a thin-film type. For example, the lithium battery may be a thin-film type battery. The lithium battery may be a lithium ion battery.

The separator may be interposed between the cathode and the anode to form a battery assembly. Alternatively, the battery assembly may be stacked in a bi-cell structure and impregnated with the electrolyte solution. The assembly may be disposed into a pouch and hermetically sealed, thereby completing the manufacture of a lithium ion polymer battery.

Alternatively, a plurality of battery assemblies may be stacked to form a battery pack, which may be used in a device that operates at high temperatures and uses high output, for example, in a laptop computer, a smart phone, electric vehicle, and the like.

The lithium battery may have improved high rate characteristics and lifetime characteristics, and thus may be applicable in an electric vehicle (“EV”), for example, in a hybrid vehicle such as plug-in hybrid electric vehicle (“PHEV”).

According to another embodiment, a method of manufacturing an anode includes: contacting a metal inert to lithium, a metal with a low reactivity with respect to lithium, and an oxide thereof, or a combination thereof, with a carbon precursor to prepare a mixture; drying the mixture to obtain a dried product; and calcining the dried product in an inert atmosphere or in a reducing atmosphere to manufacture the anode.

In the anode manufacturing method, during the calcining of the mixture of metal oxide and carbon precursor in an inert atmosphere or reducing atmosphere, and while not wanting to be bound by theory, the metal oxide is reduced into metal, resulting in a carbonaceous coating layer on the metal. That is, it is understood that a composite conducting agent with the carbonaceous coating layer on the second metal, which is inert to lithium or has low reactivity with respect to lithium, is obtained.

n the anode manufacturing method, an oxide of the metal inert to lithium or the metal with low reactivity with respect to lithium may be, for example, CuO, Cu₂O, FeO, Fe₂O₃, TiO₂, PbO, CoO, NiO, or a combination thereof, but is not limited thereto. Any oxide of a metal inert to lithium or a metal with low activity with respect to lithium may be used.

In the anode manufacturing method, the carbon precursor may comprise 2,3-dihydroxynaphthalene, pitch, tar, sucrose, polyvinylalcohol, polystyrene, phenanthrene, or a combination thereof, but is not limited thereto. Any of a suitable precursor known in the art as being able to form a carbonaceous material through calcining in an inert atmosphere may be used.

The calcining may be performed at a temperature of 500° C. or less in a reducing atmosphere, for example, in a hydrogen atmosphere.

Alternatively, the calcining may be performed at a temperature of 500° C. or higher in an inert atmosphere. For example, the calcining may be performed at a temperature of 500° C. to 1500° C., and in some embodiments, at a temperature of 700° C. to 900° C.

The calcining may be performed for 1 hour to 20 hours, and in some embodiments, for 1 hour to 10 hours, and in some other embodiments, for 1 hour to 5 hours.

When calcining the carbon precursor of a metal-carbon composite conducting agent and the metal alloyable with lithium at the same time, a carbon coated metal alloyable with lithium may be used in order to prevent thermal reaction between the metal alloyable with lithium and the carbon precursor of a metal-carbon composite conducting agent.

Hereinafter, one or more embodiments will be described in further detail with reference to the following examples. However, these examples shall not limit the scope of the disclosed embodiments.

### Preparation of Composite Conducting Agent and Anode Active Material

### Preparation Example 1

2.48 grams (g) of CuO (available from Aldrich, <5 μm, 98%) having an average particle diameter of about 5 μm was mixed with a solution of 2.0 g of 2,3-dihydroxynaphthalene in 10 g of acetone, and then evaporated the acetone. The resulting dried product was calcined at 800° C. in a nitrogen atmosphere for 3 hours to obtain carbon-coated Cu particles as a composite conducting agent.

### Preparation Example 2

1.0 g of Si nanoparticles (available from Aldrich, nanopowder, <100 nm, as measured by TEM) having an average particle diameter of about 100 nm or less was added into 10 g of a 20 wt % nitric acid solution, followed by sonication for 15 minutes, filtration, washing, and drying to obtain a dried product.

The entire dried product was mixed with a solution of 20 g of 2,3-dihydroxynaphthalene dissolved in 10 g of acetone, and then evaporated the acetone. The resulting dried product was calcined at 900° C. in a nitrogen atmosphere for 3 hours to obtain carbon-coated Si nanoparticles as a composite anode active material.

### Preparation Example 3

1.0 g of Si nanoparticles (available from Aldrich, nanopowder, <100 nm, as measured by TEM) having an average particle diameter of about 100 nm or less was mixed with a solution of 2.0 g of 2,3-dihydroxynaphthalene dissolved in 10 g of acetone, and then evaporate the acetone. The resulting dried product was calcined at 900° C. in a nitrogen atmosphere for 3 hours to obtain carbon-coated Si nanoparticles as a composite anode active material.

### Preparation Example 4

24.2 g of Si microparticles (˜325 mesh, available from Aldrich) having an average particle diameter of about 20 μm and 13.2 g of CaSi₂ microparticles (˜325 mesh, available from Aldrich) having an average particle diameter of about 40 μm were milled in a planetary mill in an argon (Ar) atmosphere for 7 hours to obtain a Si/CaSi₂ composite.

### Preparation Example 5

5 g of Si microparticles (˜325 mesh, available from Aldrich) having an average particle diameter of about 20 μm was milled in a Spex mill in an Ar atmosphere for 5 hours to obtain a Si anode active material as microparticles.

### Manufacture of Anode and Lithium Battery

### Example 1

0.04 g of the Si anode active material prepared in Preparation Example 5, 0.044 g of the composite conducting agent of Preparation Example 1, and 0.1 g of graphite (ICG10H) were mixed together using a mortar, and then with 0.246 g of a solution of 6.5 wt % of polyamide-imide (PAI, available from Torlon Co.) as a binder in N-methylpyrrolidone (NMP) to prepare an anode active material slurry.

The anode active material slurry was coated on a 15 μm-thick copper (Cu) foil, dried in an oven at about 80° C. for about 1 hour, and then in a vacuum oven at 200° C. for 2 hours, followed by being roll-pressed to manufacture an anode plate, which was then used to manufacture a coin cell (CR2032 type).

In manufacturing coin cell, metal lithium as a counter electrode, a polyethylene separator (available from Tonen Co.), and an electrolyte solution of 1.3 molar (M) LiPF₆ dissolved in a mixed solvent of ethylene carbonate (“EC”), diethyl carbonate (“DEC”), and fluoroethylene carbonate (“FEC”) in a 2:6:2 volume ratio were used.

### Example 2

0.042 g of the Si/CaSi₂ composite prepared in Preparation Example 1, 0.06 g of the composite conducting agent of Preparation Example 1, and 0.082 g of graphite (ICG10H) were mixed using a mortar, and then mixed with 0.246 g of a solution of 6.5 wt % of polyamide-imide (PAI, available from Torlon Co.) as a binder in N-methylpyrrolidone (NMP) to prepare an anode active material slurry, which was used to manufacture a test cell in the same manner as in Example 1.

### Comparative Example 1

0.035 g of the Si anode active material prepared in Preparation Example 5, and 0.149 g of graphite (ICG10H) were mixed together using a mortar, and then mixed with 0.246 g of a solution of 6.5 wt % of polyamide-imide (PAI, available from Torlon Co.) as a binder in N-methylpyrrolidone (NMP) to prepare an anode active material slurry, which was then used to manufacture a test cell in the same manner as in Example 1.

### Comparative Example 2

0.038 g of the Si/CaSi₂ composite prepared in Preparation Example 4 and 0.146 g of graphite (ICG10H) were mixed together using a mortar, and then mixed with 0.246 g of a solution of 6.5 wt % of polyamide-imide (PAI, available from Torlon Co.) as a binder in N-methylpyrrolidone (NMP) to prepare an anode active material slurry, which was then used to manufacture a test cell in the same manner as in Example 1.

### Evaluation Example 1

### X-Ray Diffraction (XRD) Measurement

The carbon-coated Cu particles as a composite conducting agent prepared in Preparation Example 1 were analyzed by XRD. An XRD spectrum of the composite conducting agent is shown in FIG. 2.

Referring to FIG. 2, peaks from Cu were observed and nearly no CuO-related peak (CuO is understood to likely appear at an initial stage) was observed. This indicates that reduction of CuO into Cu occurred during formation of a carbon coating layer.

### Evaluation Example 2

### Electrical Conductivity and Density Measurement

Conductivities and densities of the composite conducting agents and/or anode active materials of Preparation Examples 1 to 5 were measured. The results are shown in Table 1, along with those of graphite for comparison.

The conductivities and densities were measured using a resistance measurement system (MCP-PD 5, available from Mitsubishi Chemical Co.) at room temperature and a pressure of about 20 N.

TABLE 1

| | Conductivity | Density |
|---|---|---|
| | [S/cm] | [g/cc] |
| Graphite (ICG10H) | 6.55 × 10² | 2.61 |
| Preparation Example 1 | 6.97 × 10¹ | 4.55 |
| Preparation Example 2 | 4.30 × 10⁻⁷ | 1.14 |
| Preparation Example 3 | 2.79 × 10⁻³ | 0.94 |

Referring to Table 1, the composite conducting agent of Preparation Example 1 has a density of 4 g/cc or greater and a conductivity of 1 S/cm or greater. The anode active material of Preparation Example 2 has a higher conductivity than that of the anode active material of Preparation Example 3. This is attributed to that the acid-treated surface of the anode active material with more hydroxyl (OH) groups reacted with more 2,3-dihydroxynaphthalene which is used as carbon precursor.

### Evaluation Example 3

### Evaluation of Charge-Discharge Characteristics

The coin cells manufactured in Examples 1 and 2 and Comparative Examples 1 and 2 were each charged at about 25° C. with a constant current of 0.1 C rate to a voltage of 0.01V (with respect to the Li metal), followed by charging at a constant voltage of 0.01V to current of 0.01 C, a rest period for 10 minutes, and discharging at a constant current of 0.1 C to a voltage of 1.5V (with respect to Li).

Subsequently, each of the cells was charged at a constant current of 0.2 C rate to a voltage of 0.01V (with respect to Li), and then charged at a constant voltage of 0.01V to a current of 0.01 C, followed by a rest period for 10 minutes, and discharging at a constant current of 0.2 C to a voltage of 1.5V (with respect to Li) (formation process).

Each of the lithium batteries after the formation process was charged at about 25° C. with a constant current of 1.0 C rate to a voltage of 0.01V (with respect to Li), and then charged at a constant voltage of 0.01V to a current of 0.01 C, followed by a rest period for 10 minutes and discharging at a constant current of 1.0 C to a voltage of 1.5V (with respect to Li). This cycle was repeated 20 times. The results of the charging/discharging test are shown in part in Table 1 below.

The expansion ratio, capacity retention, and discharge capacity at 1^{st} cycle or 20^{th} cycle were calculated using Equations 1 to 3, respectively.

The density of an electrode from each coin cell was calculated from the weight and thickness of the electrode in circular form having a diameter of about 12 mm obtained by punching, excluding the weight and thickness of a substrate (Cu foil) of the electrode.

For the calculation of the expansion ratio using Equation 1, the thickness of the electrode was measured using a digital micrometer (available from Mitutoyo Corporation).

Expansion ratio [%]=[(Thickness of anode plate after charging at 1^{st} cycle−Initial thickness of anode plate)/Initial thickness of anode plate]×100 Equation 1

Capacity retention [%]=[Discharge capacity at 20^{th} cycle/Discharge capacity at 1^{st} cycle]×100 Equation 2

Actual discharge capacity=[Discharge capacity per unit volume/(1+(Expansion Ratio/100))], wherein Discharge capacity per unit volume=Discharge capacity per unit weight×Amount of active material×Density of electrode mixture Equation 3

The density of the dried anode active material slurry corresponds to the density of the electrode.

TABLE 2

| | 1^{st} Cycle | 1^{st} Cycle | Electrode | | 1^{st} Cycle Actual | Capacity |
|---|---|---|---|---|---|---|
| | discharge capacity | discharge capacity | mixture density | Expansion | Discharge capacity | retention |
| Example | [mAh/g] | [mAh/cc] | [g/cc] | ratio [%] | [mAh/cc] | [%] |
| Comparative | 954 | 1455 | 1.66 | 100.0 | 727 | 85.0 |
| Example 1 | | | | | | |
| Example 1 | 1313 | 1394 | 1.52 | 82.4 | 764 | 89.1 |
| Comparative | 819 | 1113 | 1.48 | 82.9 | 608 | 86.0 |
| Example 2 | | | | | | |
| Example 2 | 1238 | 1134 | 1.48 | 80.5 | 628 | 90.8 |

Referring to Table 2, the lithium batteries of Examples 1 and 2 have similar discharge capacities per unit volume, lower expansion ratios, and better capacity retention, and higher actual discharge capacities, compared to those of the lithium batteries of Comparative Examples 1 and 2.

As described above, according to one or more of the above embodiments, a lithium battery including a high-density metal-carbon composite conducting agent may be improved in actual discharge capacity per unit volume, which is determined in consideration of the volume or thickness expansion of the electrode, and in capacity retention.

It shall be understood that the exemplary embodiments described herein shall be considered in a descriptive sense only and not for purposes of limitation. Descriptions of features, advantages, or aspects within each embodiment shall be considered as available for other similar features, advantages, or aspects in other embodiments.

What is claimed is:

1. An anode comprising:
an anode active material comprising a first metal alloyable with lithium; and
a metal-carbon composite conducting agent having a density of 3.0 grams per cubic centimeter or greater.

2. The anode of claim 1,
wherein the metal-carbon composite conducting agent is a composite of
a carbonaceous material, and
a second metal, which is a metal inert to lithium or a metal with low reactivity with respect to lithium, an oxide thereof, or a combination thereof.

3. The anode of claim 2, wherein an amount of the carbonaceous material is 50 weight percent or less, based on a total weight of the metal-carbon composite conducting agent.

4. The anode of claim 1,
wherein the metal-carbon composite conducting agent comprises a core comprising a second metal, an oxide thereof, or a combination thereof; and
a carbonaceous material disposed on at least a portion of the core of the metal-carbon composite conducting agent,
wherein the second metal is a metal inert to lithium or a metal with low reactivity with respect to lithium.

5. The anode of claim 1, wherein the first metal has a lithium specific capacity of greater than 150 milliampere-hours per gram.

6. The anode of claim 2, wherein the second metal has a lithium specific capacity of less than 10 milliampere-hours per gram.

7. The anode of claim 4, wherein the second metal having a lithium specific capacity of less than 10 milliampere-hours per gram comprises copper (Cu), iron (Fe), zinc (Zn), titanium (Ti), stainless steel, lead (Pb), cobalt (Co), nickel (Ni), or a combination thereof.

8. The anode of claim 4, wherein the oxide of the second metal comprises CuO, Cu₂O, FeO, Fe₂O₃, TiO₂, PbO, CoO, NiO, or a combination thereof.

9. The anode of claim 4, wherein the core is in the form of a particle, a fibrous, a plate, or a combination thereof.

10. The anode of claim 4, wherein the carbonaceous material has a thickness of 100 nanometers or less.

11. The anode of claim 4, wherein the carbonaceous material is amorphous or low crystalline.

12. The anode of claim 1, wherein the composite conducting agent has a conductivity of 10⁻¹ Siemens per centimeter or greater.

13. The anode of claim 1, wherein the first metal alloyable with lithium comprises Si, Ge, Sn, or a combination thereof.

14. The anode of claim 1, wherein the anode active material comprises:
a core comprising the first metal alloyable with lithium; and
a carbonaceous material disposed on the core of the anode active material.

15. The anode of claim 1, wherein the anode active material has a conductivity of 10⁻⁴ Siemens per centimeter or greater.

16. The anode of claim 1, wherein the anode active material and the composite conducting agent are in a form of an electrode.

17. The anode of claim 16, wherein the anode does not directly contact a current collector which is attached to the electrode.

18. A lithium battery comprising the anode of claim 1.

19. A method of manufacturing an anode, the method comprising combining a metal-carbon composite conducting agent, an anode active material comprising a first metal alloyable with lithium, and a binder to form the anode, wherein the metal-carbon composite conducting agent is manufactured by:
contacting a second metal, an oxide thereof, or a combination thereof and a carbon precursor to prepare a mixture;
drying the mixture to obtain a dried product; and
calcining the dried product in an inert atmosphere or in a reducing atmosphere to manufacture a metal-carbon composite conducting agent,
wherein the second metal is a metal inert to lithium or a metal with low reactivity with respect to lithium.

20. The method of claim 19, wherein the oxide of the second metal comprises CuO, Cu₂O, FeO, Fe₂O₃, TiO₂, PbO, CoO, NiO, or a combination thereof.
